(19) United States
(12) Patent Application Publication
(10) Pub. No.: US 2018/0189791 A1
(43) Pub. Date: Jul. 5, 2018

(54) METHODS AND SYSTEM FOR ADDRESSING LOCATIONS WITH PERSONALIZED AND USER-SELECTED TAGS

(71) Applicant: QATAR UNIVERSITY QSTP-B, Doha (QA)

(72) Inventor: Fethi FILALI, Doha (QA)

(21) Appl. No.: 15/395,776

(22) Filed: Dec. 30, 2016

(51) Int. Cl. G06Q 30/00; G06Q 30/04; G06F 17/30; G06Q 10/08

(52) U.S. Cl. CPC G06Q 30/01; G06Q 10/0838; G06F 17/30241; G06Q 30/04

(57) ABSTRACT

Methods and system for addressing geographical locations/physical addresses with personalized and user-defined location tags that allow individuals and entities to define a simple and unique tag to represent each physical location such as building, person's current location. The system comprises: a tag management unit capable of assigning and managing the personalized unique location tag to the specific physical location; at least a communication device capable of facilitating access to the services of the tag management unit; at least a smart device application module capable of being installed or embedded with the communication device for facilitating the user to access to the services of the tag management unit. The tag management unit, the personalized unique location tag, the smart device application module, the communication device, a third-party application module, a web application module are communicably connected with each other through a communication network.

### FIELD OF THE INVENTION

The present invention generally relates to locating geographical locations, and more particularly to methods and system for addressing physical locations with personalized and user-selected unique tags to easily locate the addresses of registered users.

### BACKGROUND OF THE INVENTION

The address information is one the core enablers for shipment and delivery of bought items. It is also important in other cases like booking a taxi, asking for help from public safety authority, and easily found or located by visitors and friends.

With the proliferation of online stores where users need to create online accounts which capture their information, it becomes challenging to keep these information up-to-date. While fields like name, birthday and few others details concerning a person/human do not change over time, physical addresses usually need to be updated during human lifetime, for example, in many cases the person moves from one location to other location, from one flat to another flat, from one city to another city, or even to another country. Alternatively, one can have multiple valid physical addresses but he/she wants to use only one address for any specific period of time for all corresponding shipments or correspondences.

Explaining the exact address/location by phone to others (e.g., delivery man, visitors, friends, taxi drivers, public safety officers, etc.) to be reached out, it is usually not precise and also difficult to communicate. It may result in repeating the explanation multiple times, using landmarks as references without any guarantee that the second party gets it right and will be possible for him to come to the location without further calls and explanations. In many of the cases, it may happen that the second party gets lost and/or has to call the user or target person multiple times to be able to reach out the exact location.

An attempt has been made to solve the world addressing problem by translating every 2D geo-location (latitude, longitude) to a predefined three-word string, for example, the What3Words http://what3words.com/ tries to solve the problem but it does not allow users to select their own tags and map a tag to a specific location and owner since it assigns unique 3 words to every location in the world map.

In view of the existing problem of easily locating geographical locations/physical addresses, there exists a strong need of means capable of addressing geographical locations with personalized and user-selected tags to easily and quickly locate the addresses of registered users.

### SUMMARY OF THE INVENTION

In view of the foregoing disadvantages inherent in the prior-art, the general purpose of the present invention is to provide methods and system for addressing geographical locations with personalized and user-selected tags to easily and quickly locate the addresses of registered users, while including advantages of the prior art with some added advantages and to overcome the drawbacks inherent therein.

In one aspect, the present invention provides a system for designating/tagging at least a physical location of a registered user with at least a personalized unique tag to easily locate the physical location. The system comprises: a tag management unit capable of assigning and managing the personalized unique location tag to the specific physical location; at least a communication device capable of facilitating access to the services of the tag management unit; at least a smart device application module capable of being installed or embedded with the communication device for facilitating the user to access to the services of the tag management unit. The tag management unit, the personalized unique location tag, the smart device application module, the communication device, a third-party application module, a web application module are communicably connected with each other through a communication network. The registered user is connected to the tag management unit through the communication network by using the communication device.

In another aspect, the tag management unit of the present invention comprises at least one of at least a tag management module capable of verifying and validating personalized unique location tag assignment and updating requests received from the users; at least a user management module capable of performing user profiling and suggesting at least an appropriate personalized unique location tag to assign for the specific physical location of the user; at least an enterprise management module capable of allowing enterprises to access services of the tag management unit, wherein the services include personalized unique location tags and their associated physical addresses, user profiles and user information; at least an usage monitoring and billing module capable of keeping track of number of calls of services provided by the tag management module and making usage of each enterprise in compliance with an enterprise subscription model, wherein the usage monitoring and billing module comprises a billing unit with at least a pre-defined pricing model for generating bills corresponding to uses of the tag management module by the user and securing the payments against the generated bills; at least a service management module capable of managing services provided by the tag management unit; at least a database module having at least one of a real time database, a historical database, and an analytics database, wherein the real time database is capable of storing users and enterprises information as well as active tag assignment, wherein the historical database is capable of keeping all historic data in terms of services usage, ended tag assignments, changes of users' profiles, wherein the analytics database includes a data that is used for analytics purpose; at least a security and access control module capable of implementing the tag management module, the user management module, the enterprise management module, the usage monitoring and billing module, the service management module, the database module, and intelligence needed to secure the tag management unit and facilitating the access to each service of the tag management unit only to authorized registered users and enterprises.

In another aspect, the present invention provides a method to generate at least a personalized unique tag for at least a physical location. The method comprises the steps of: creating at least a user profile corresponding to the physical location and an exact address of the physical location by using a smart device application module of a tag management module; requesting for adding a personalized unique tag to at least a preferred physical location address of the user; checking validity or acceptance of the personalized unique tag; and confirming to the user availability of the personalized unique tag. The method further comprising the steps of: generating the personalized temporary unique tag by the user for a current location of the user in emergency scenarios; sharing the generated personalized unique tag with a plurality of entities including public safety agencies, friends, and relatives; and retrieving automatically a physical address of the current location of the user. The generated personalized unique tag is either chosen by the user or even suggested by the tag management module

In yet another aspect, the present invention provides a method for getting a physical location address from the personalized unique tag of the user for a delivery of at least an online booked item online. The method comprises the steps of: adding or sharing the personalized unique tag with the online booked item or with an e-commerce company for the delivery of the online booked item at the physical location associated with the personalized unique tag; requesting an exact physical location of the user from the tag management module by the e-commerce company; and providing or confirming the exact physical location of the user to the e-commerce company.

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1A is an environmental view of a system for designating a specific physical location of a user with an personalized and user selected unique location tag, according to an exemplary embodiment of the present invention;

FIG. 1B illustrates a block diagram of the system for designating the specific physical location of the user with the personalized and user-selected unique location tags, according to an exemplary embodiment of the present invention;

FIG. 1C illustrates an exemplary communication device incorporating a smart device application module, according to an exemplary embodiment of the present invention;

FIG. 2 illustrates a flow graph of a method to generate the personalized and user selected unique location tag for a specific physical location, according to an exemplary embodiment of the present invention;

FIG. 3 illustrates a flow graph of a method forgetting physical address of the specific physical location from the user's personalized unique location tag, according to an exemplary embodiment of the present invention;

FIGS. 4A and 4B illustrate flow graphs of a method for generating the personalized unique location tag by the user for a current location of the user and sharing the generated tag with many entities, according to an exemplary embodiment of the present invention;

FIG. 4C illustrates a method for validation and assignment of the personalized unique location tag to the specific physical locations of the user during a selected time periods, according to an exemplary embodiment of the present invention;

FIG. 5A illustrates a method for assignment of the personalized unique location tag to different physical locations during different time periods, according to an exemplary embodiment of the present invention; and

FIG. 5B illustrates a method for assignment of the personalized unique location tag to the physical locations of the user during a selected time periods, according to an exemplary embodiment of the present invention.

### DETAILED DESCRIPTION OF THE INVENTION

The exemplary embodiments described herein detail for illustrative purposes are subject to obvious variations in method steps and system configuration. It should be emphasized, however, that the present invention is not limited to particular method and system for tagging physical locations with personalized and user-selected tags to easily and quickly locate the addresses of registered users, as shown and described, rather the principles of the present invention can be used with a variety of methods and structural arrangements for accurately and hassle free locating user selected physical locations. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The use of terms “including”, “comprising” or “having” and variations thereof herein are meant to encompass the items listed thereafter and equivalents thereof as well as additional items. Further, the term “plurality” refers to the presence of more than one of the referenced item and the terms, “a”, “an” and “at least” herein do not denote a limitation of quantity, but rather denote the presence of at least one of the referenced item. The term “system” also includes “machine”, “device”, and “apparatus”. The terms “physical location”, “specific physical location”, “specified physical location”, “geographical location”, “physical address”, “user selected physical location” refer the same thing and may be used herein interchangeably. The term “personalized unique location tag”, “personalized unique tag”, “unique location tag”, “unique tag”, “location tag” or “tag” refer the same thing and may be used herein interchangeably. The term “tag management system” and “tag management unit” refer the same thing and may be used herein interchangeably.

The present invention provides simplified methods and system for addressing or designating physical addresses of registered users by associating personalized and user-selected tags to the physical addresses. The registered users may choose and share the selected personalized tags with other entities for quickly and easily locating exact physical addresses of the registered users without requiring repeated explanation or direction from users, for delivery or pick-up, shipment, public safety requirements, taxi services, etc. The entities may include e-commerce companies, postal man, safety officials, taxi drivers, couriers, companies dealing in the delivery and pick-up of products, etc. The methods and system of the present invention is highly scalable and may be integrated or embedded with low-complexity and resource limited devices.

According to an exemplary embodiment, the present invention provides a central place of storing and managing physical addresses of users and facilitates their simplifies sharing between users and other entities or parties, thereby increasing the accuracy of address information exchanged between parties and removes the issues related to explain many times the exact physical location.

The present invention is capable of verifying and validating at least a user selected tag to be assigned to one of preferred locations or addresses of the user, for example, home, work, touristic or travel destination etc. Upon validation, the user selected tag may be used by the user in any shipment systems and may be shared with relatives, visitors, friends, delivery persons, couriers, postman, companies, companies dealing in the delivery and pick-up of online brought products, and may also be made public. Each tag may be assigned with a validity period depending on at least a predefined criteria or rule.

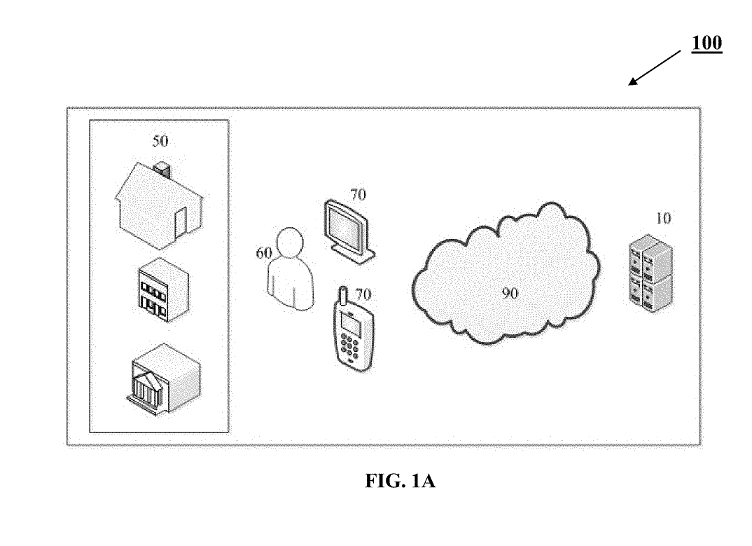

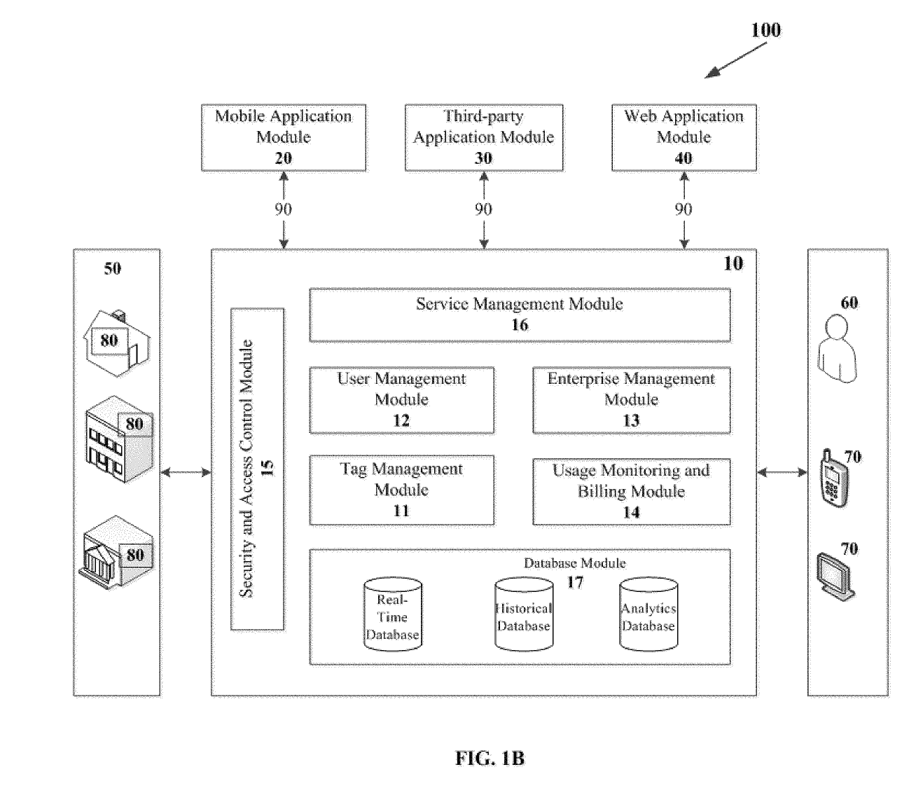

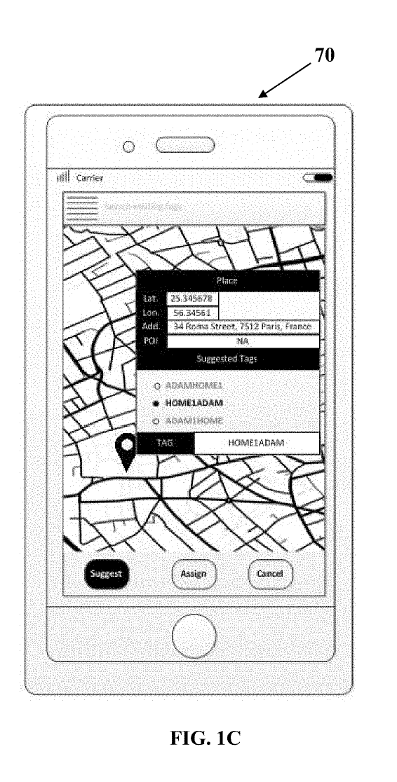

Referring to FIG. 1A which is an environmental view of an exemplary system 100 of the present. Referring to FIG. 1B which illustrates a block diagram of the system 100 for designating at least a specific physical location 50 of a registered user 60 with a personalized and user-selected unique location tag 80, according to an exemplary embodiment of the present invention.

The system 100 comprises at least one of a tag management unit 10, at least the location tag 80, at least a smart device application module 20, at least a communication device 70 or any combination thereof.

At least one of the location tag 80, the smart device application module 20, the user 60, the communication device 70, a third-party application module 30, a web portal module 40 or any combination thereof may be communicably/operably connected with the tag management unit 10 through a communication network 90. The location tag 80 may include a RFID tag or any tag capable of being personalized and assigned with a tag id or tag value and also to communicate with the tag management unit 10.

The smart device application module 20 is capable of being installed/embedded or integrated with the communication device 70. The tag management unit 10 may be integrated with other existing systems, for example, postal services companies, delivery or shipment companies, e-commerce companies, public safety service companies, taxi services companies, social applications, etc., may choose to integrate their existing systems with the tag management unit 10 to access seamlessly the available services provided by the tag management unit 10, for example, easily locating the physical location 50 of registered users 60.

The third party application module 30 is capable of authorizing a third party access to services of the tag management unit 10 according to predefined agreement and rules stored in the security and access control module 15.

The third party includes an individual, a friend, a relative, a cab driver, a postal delivery person, a courier or shipment delivery person or company, an enterprise or company including an e-commerce company, an administration entity, a public safety agency, a postal service provider, a cab service provider, etc,

The web application module 40 includes a designated online web-portal. The web application module 40 is capable of providing the user 60 access to the tag management unit 10. The web application module 40 comprises a graphical user interface that may be accessed using any web browser to do operations like view, manage user profiles, and manage and search for tags.

The physical location 50 of the user 60 includes a home, a secondary home, a work place, a travel or a tour destination, and others.

The user 60 includes a person or an entity registered and authorised to access the tag management unit 10 for managing their location tag 80 and services related therein with the location tag 90. The user 60 may be connected with the tag management unit 10 through any of the smart device application module 20, the third party application module 30, and the web application module 40 by using the communication device 70 over the communication network 90.

The location tag 80 is unique and personalized for the specific physical location 50 of the user 60. The user 60 may personalize and select the location tag 80 according to his/her physical location 50 assigned/recorded with the location tag 80. The location tag 80 may be assigned with a tag value. The tag value, for example, may be an alphanumeric string that is uniquely assigned to the user 60 and matched with the corresponding physical location 50 of the user 60. The tag management unit 10 is capable of assigning the tags 80 to the user's addresses 50. The assigned tags 80 are unique and not assigned to any other user.

When the user 60 needs to communicate his/her physical location 50 to other entities or a third party, he/she just needs to let the third party know the tag value. The third party may then get the exact physical location either seamlessly by integrating their platform to the tag management unit 10 or by getting the tag value through at least one of the online web portal 40, smart device application module 20, and the third party application module 30.

The communication device 70 may include a smart phone, a smart watch, a smart device, a smart navigational system, a PDA, a desktop, a laptop or the like smart devices capable of communicating over the communication network 90.

The communication network 90 includes wireless communication network and wired communication network, for example, Internet, Wi-Fi Bluetooth or any other communication network capable of facilitating data transfer/exchange and communication between the tag management unit 10, the communication device 70, the smart device application module 20, the third-party application module 30, the web application module 40.

In some embodiments of the present invention, restrictions of uniquely assigning the tags 80 may be limited to the same country or city especially for big countries. In another embodiment of the present invention, the user 60 may select and use his/her preferred language to generate the location tag 80.

The tag management unit 10 comprises at least one of at least a tag management module 11, at least a user management module 12, at least an enterprise management module 13, at least an usage monitoring and billing module 14, at least a security and access control module 15, at least a service management module 16, and at least a database module 17 or any combination thereof.

The tag management module 11 is in charge of verifying and validating tag assignment and update requests received from the users 60 based on a specific implemented intelligence such as making sure that the chosen tag 80 is alphanumeric, the chosen tag 80 is not being already assigned to another person, and validity start and end dates of the chosen tag 80 are correct, etc.

The user management module 12 is capable of handling users profile in terms of creation, update, delete, and assigning a role such as user or an admin, etc. Based on the historic data and previous usage of the tag management module 11, the user management module 12 may perform user profiling and may suggests at least an appropriate location tag 80 to assign for the physical locations 50 of the user 60.

The enterprise management module 13 may allow the access for companies, enterprises or entities to services of the tag management unit 10 including the stored tags 80 and their associated physical addresses 50 as well as the user information (if authorized). The level of details and the coverage area of the acceded data may depend on an enterprise subscription model and the authorization chosen by every user 60 to access his/her information in terms of user's profile and location tags 80.

The usage monitoring and billing module 14 is capable of keeping track of the number of calls of the services provided by the tag management module 11 and making sure that the usage of each enterprise is compliant with the concerned enterprise subscription model. The usage monitoring and billing module 14 comprises a billing unit with at least a pre-defined pricing model for generating bills corresponding to uses of the tag management module 11 by the user 60 and securing the payment against the generated bills.

The security and access control module 15 is capable of implementing all the components i.e., the tag management module 11, the user management module 12, the enterprise management module 13, the usage monitoring and billing module 14, the service management module 16, the database module 17 of the tag management unit 10 and intelligence needed to make sure the tag management unit 10 is secure and the access to each service of the tag management unit 10 is only given to authorized users 60 and enterprises.

The service management module 16 capable of managing services provided by the tag management unit 10 to the users 60 and enterprises. The services may include personalized unique location tags 80 and their associated physical addresses 50, user profiles and user information, searching for tags 80, editing tag 80, user 60, and physical addresses 50 information, creating and managing third parties, etc.

The database module 17 includes at least one of a real time database, a historical database, and an analytics database. The real time database is capable of storing users and enterprises information as well as active tag assignment. The historical database is capable of keeping all historic data such as services usage, ended tag assignments, changes of users' profiles (added/removed/update locations, tags), etc. The analytics database includes a data that is used for analytics purpose.

Referring to FIG. 1C which illustrates an exemplary communication device 70 incorporating the smart device application module 20, according to an exemplary embodiment of the present invention. As it is shown in FIG. 1C, the smart device application module 20 or a dedicated web portal may be used to provide the user 60 access to the tag management unit 10 wherein the user 60 may also manage his/her profile as well as all personalized unique location tags 80 assigned to stored physical locations 50 of the user 60. The user 60 may have the option to search for all existing personalized unique location tags 80 without knowing the information about the associated users. The users 80 may have to opt for making their personalized unique location tags 80 searchable by other users or entities.

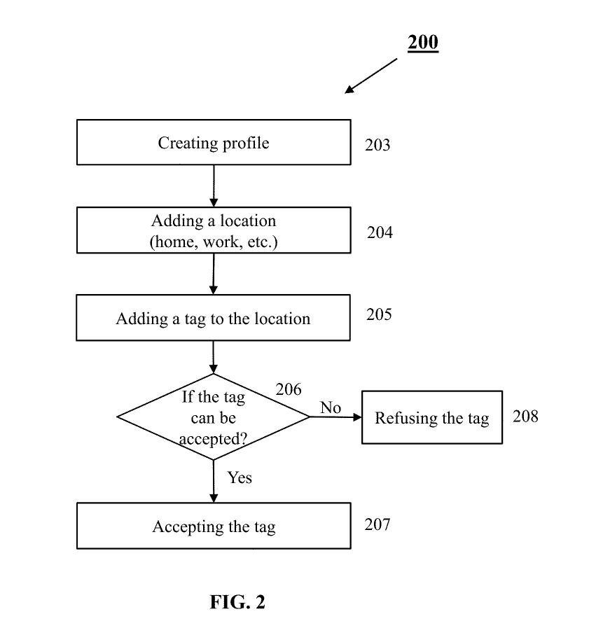

Referring to FIG. 2 which illustrate flow graph of a method 200, to generate a personalized unique location tag 80 for a specific physical location, according to an exemplary embodiment of the present invention. The method 200 starts at a step 203 wherein the user 60 creates his/her profile by using any of the web application module 40, the designated online web-portal, the third party application module 30, and the mobile application module 20. A part of the information that the user 60 may add to his/her favorite is his/her geographical/physical locations as shown at a step 204. For each location, the user 60 may provide a type of location/place, for example, a home, a work place, secondary home, office, a travel or tour destination, etc., and an exact address for the physical location/place.

The exact address may also include at least one of a building number, a street name, a zip code, a city name, and a country name, or a latitude/a longitude geo-point that may be selected from a map available in the smart device application module 20 or any other addressing standard specific for some countries. For example, the address standard used in Qatar includes a combination of a building number, a street number, a zone number.

At a step 205, the user 60 requests for adding a personalized unique tag to at least a preferred physical location of the user 60. At a step 206 the tag management module 11 needs to check that the location tag 80 is valid and available. At steps 207 and 208, the tag management module 11 sends a confirmation back to the user 60 concerning the validity of the location tag 80, i.e., acceptance or refusal of the location tag 80. The steps 206 and 207 may be repeated more than one time for different user's addresses and till finding a valid and available location tag 80 for each one of the different users.

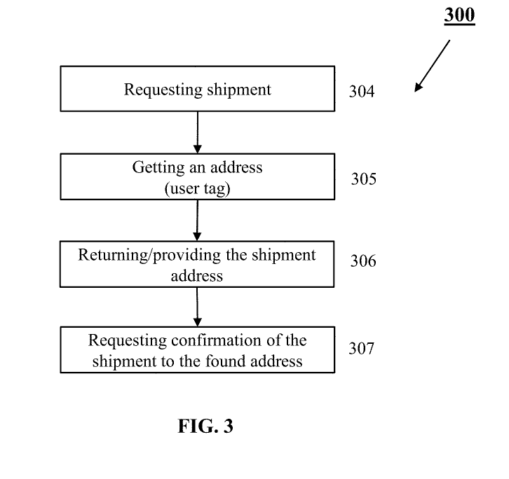

Referring to FIG. 3 which illustrates flow graph of a method 300 for getting an address of the physical location 50 from the location tag 80 of the user 60 for delivery of at least an online booked item, according to an exemplary embodiment of the present invention. The user 60 requesting the shipment or delivery of any items, may add his/her personalized unique location tag 80 with the online booked item/shipment or share the personalized unique location tag 80 with the shipment or the shipping/e-commerce company. If the user 60 is making orders by phones, for example for food or taxi, he/she may communicate his/her location detail or details of the location tag 80 directly to the operator. In all cases, the e-commerce company or the third party may request the exact physical location from the tag management module 11 at a step 305 and retrieve the exact physical location 50 at a step 306. The address of the physical location 50 may be then confirmed or provided to the user 60 over the communication device 70 or through the online web portal of the company as shown at a step 307. The retrieval of the address of the physical location 50 may be either carried out automatically by integrating the company's system with the tag management unit 10 or by consulting at least one of the web application module 40, the dedicated web-portal, the smart device application module 20.

According to an embodiment of the present invention, shipment systems of different companies/vendors or online web portals may integrate with the tag management system 10 to retrieve the real/exact physical location 50 of a given personalized unique location tag 80. Users 60 may also check actual locations of any given location tag 80 and availability of strings that may be used as location tags, through the web application module 40 or the online web portal.

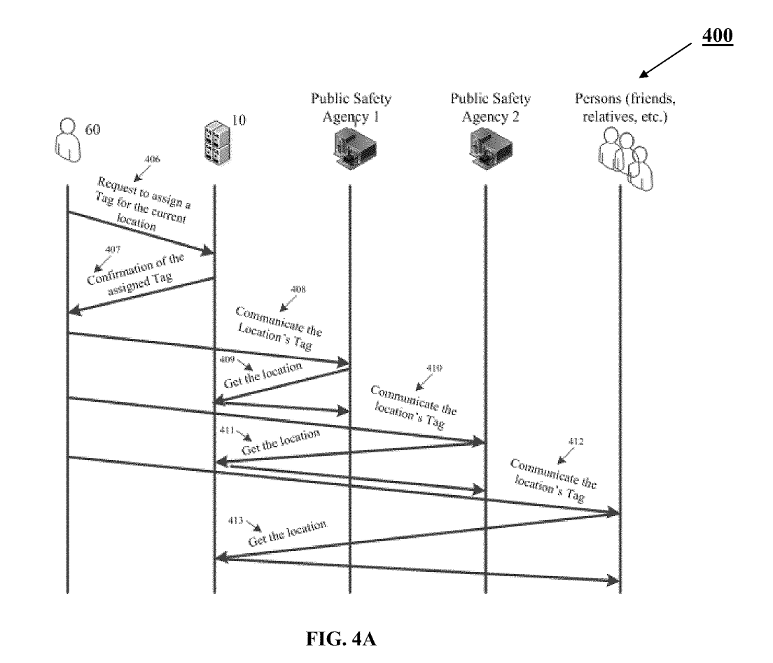

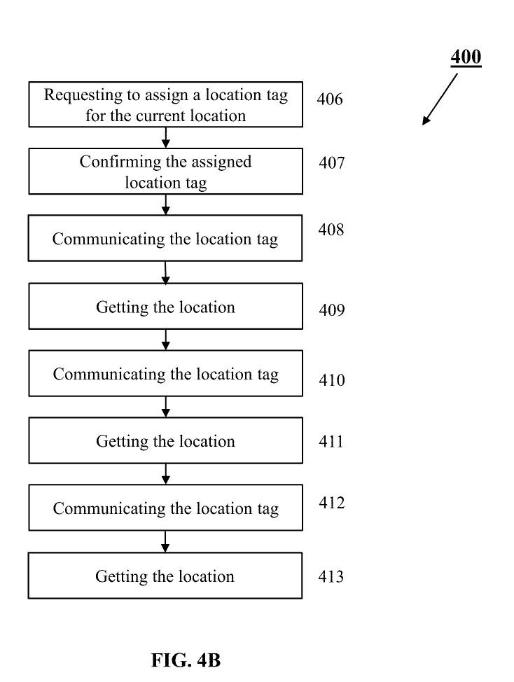

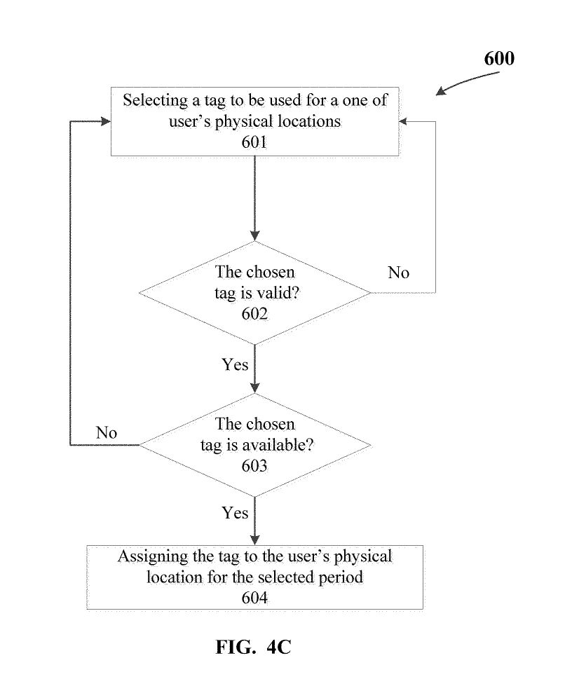

Referring to FIGS. 4A and 4B which illustrate flow graphs of a method 400 for generating the personalized unique location tag 80 by the user 60 for a current location of the user 60 and sharing the generated personalized unique location tag 80 with many entities, according to an exemplary embodiment of the present invention. In a case, for example, in emergency scenarios, the user 60 may generate the personalized unique location tag 80 for his current location and may share the generated location tag 80 with more than one entity including public safety agencies, friends, and relatives, etc. The generated location tag 80 may be either chosen by the user 60 or even suggested by the tag management module 11 to make this step faster and easier to the user 60. The location tag 80 may then be communicated to all other entities as shown at steps 408, 410, and 412. A real address of the physical location 50 is retrieved automatically from the tag management module 11 as shown at steps 409, 411, and 413.

Referring to FIG. 4C which illustrates a method 600 for validation and assignment of a tag 80 to user's physical locations 50 during a selected time periods, according to an exemplary embodiment of the present invention. The method 600 comprises the steps of selecting the location tag 80 at a step 601, validating the selected location tag 80 at a step 602, checking whether the selected location tag 80 is available at a step 603, and assigning the location tag 80 for a selected period to the physical location 50 of the user 60 at a step 604.

The user 60 selects the location tag 80 to be used for one of the physical locations 50. The tag management module 11 verifies first if the location tag 80 is valid according to predefined set of rules, for example, a particular set of predefined rules may includes alphanumeric, a min length of 2 characters and max length of 50 characters, does not include special characters, etc. If the chosen location tag 80 is not valid, the tag management module 11 asks the user 60 to select a new location tag 80. In case the new location tag 80 is valid, the tag management module 11 verifies if the tag 80 is available for the time duration selected by the user 60. If the location tag 80 is available, then the location tag 80 is assigned to the user 60 and linked to the physical location 50 of the user 60 for the selected period of time. In the event that the location tag 80 is already assigned to another user 60, the tag management module 11 provides the user 60 to choose a new location tag and the method 600 may continue till finding a valid and available location tag 80 or the user 60 may cancel the operation.

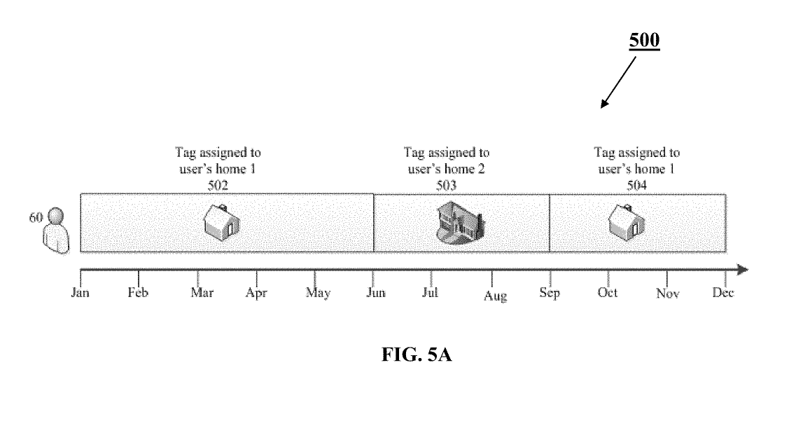

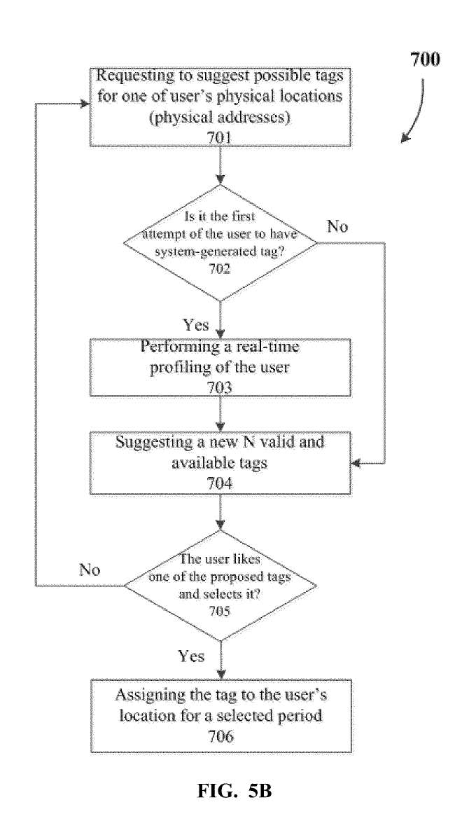

Referring to FIG. 5A which illustrates a method 500 for assignment of the location tag 80 to different physical locations 50 during different time periods, according to an exemplary embodiment of the present invention. The user 60 may choose to assign the location tag 80 to different physical locations 50, for example, a home-1, a home-2 of the user 60, in non-overlapping time periods, for example, if the user 60 chooses a location tag 80 to be assigned every year or on a specific year to his/her home-1 from September to June and to his home-2 from June to August. Additionally, the selected location tag 80 may be valid for a predefined period of time.

Referring to FIG. 5B which illustrates a method 700 for assignment of the location tag 80 to the physical locations 50 of the user 60 during a selected time periods, according to an exemplary embodiment of the present invention. The user 60 has the option to ask the tag management unit 10 at a step 701 to suggest possible location tags 80 that user 60 may use for one of his physical locations 50. At a step 702, a check is performed to know whether this is the first attempt of the user 60 to get a system-generated location tag 80. In case of the first attempt at the step 702 by the user 60, the tag management unit 10 may do real-time profiling of the user 60 to understand the possible location tags 80 in which the user 60 may be interested.

The profiling process may be based, for example, on the user-related information (name, gender, age, current location, etc.) as well as any previous selected location tags 80. Based on the determined profile of the user 60, at a step 704 the tag management unit 10 may proposes up to “N” available and valid tags to the user 60 to select from. The “N” may be a configurable parameter in the tag management unit 10 which by default may be equal to 3. Then the user 60 may select one of the proposed location tags or ask the tag management unit 10 to generate new “N” location tags 80. At a step 705, if the user 60 likes one of the proposed location tags 80 and selects it, then at a step 706 the location tag 80 may be assigned to the physical location 50 of the user 60 for the selected period of time. At every step of the method 700, the user 60 may choose to enter instead his/her proposed location tag 80 and get the tag management unit 10 to check its validity and availability using the method 600, as described in FIG. 4C.

The user 60 can decide to update/remove the location tags 80 assigned to his physical locations 50. For example, the user 60 may select a new location tag or update his/her home address. The user 60 may remove an address and all associated information from his/her profile.

In all possible embodiments, different users 60 may choose distinct location tags 80 to be assigned to the same physical locations 50. For example, this may be the case of a work location where multiple persons are working and may choose to assign different location tags 80 to the same work address or physical location 50.

In another embodiment, the user 60 may choose to create a temporary location tag 80 for his current physical location 50 and share it with any external or third party including public safety agencies, friends, etc.

In a different embodiment, the tag management module 11 may propose to the user 60 possible available location tags that may be selected depending in his stored preferences that include the language, hobbies, areas of interest, etc.

The user 60 may assign its preferred tag to the physical location 50. The user 60 may have addresses of multiple physical locations 50 stored in the tag management module 11 and for each one of them an assigned location tag 80. The user 60 may create a new physical address on-the-fly as needed and assign the location tag 80 to the new physical address 50 (for example the one of his current location). The tag management module 11 capable of suggesting or assigning few available personalized unique location tags to the user 60 depending on his/her profile and preferences. The assigned or suggested location tag 80 may be valid for only a specific period or unlimited duration. The owner/user 60 of each location tag 80 may update the location tag 80 anytime through any of the smart device application module 20, the third party application module 30, and the web application module 40 or the dedicated online web-portal.

The methods 200-700 may be executed, for example, by a system, such as the tag management unit 10. Operations of the flowchart and combinations of operation in the flow charts may be implemented by various means, such as hardware, firmware, processor, circuitry and/or other device associated with execution of software.

Also, techniques, devices, subsystems and methods described and illustrated in the various exemplary embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled to each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

What is claimed is:

1. A system for tagging at least a specific physical location of a registered user with at least a personalized unique location tag to easily locate the specific physical location, the system comprising:
a tag management unit capable of assigning and managing the personalized unique location tag to the specific physical location,
the tag management unit comprising at least one of
at least a tag management module capable of verifying and validating personalized unique location tag assignment and updating requests received from the users,
at least a user management module capable of performing user profiling and suggesting at least an appropriate personalized unique location tag to assign for the specific physical location of the user,
at least an enterprise management module capable of allowing enterprises to access services of the tag management unit, wherein the services include personalized unique location tags and their associated physical addresses, user profiles and user information,
at least an usage monitoring and billing module capable of keeping track of number of calls of services provided by the tag management module and making usage of each enterprise in compliance with an enterprise subscription model, wherein the usage monitoring and billing module comprises a billing unit with at least a pre-defined pricing model for generating bills corresponding to uses of the tag management module by the user and securing the payments against the generated bills,
at least a service management module capable of managing services provided by the tag management unit,
at least a database module having at least one of a real time database, a historical database, and an analytics database, wherein the real time database is capable of storing users and enterprises information as well as active tag assignment, wherein the historical database is capable of keeping all historic data in terms of services usage, ended tag assignments, changes of users' profiles, wherein the analytics database includes a data that is used for analytics purpose; and
at least a security and access control module capable of implementing the tag management module, the user management module, the enterprise management module, the usage monitoring and billing module, the service management module, the database module, and intelligence needed to secure the tag management unit and facilitating the access to each service of the tag management unit only to authorized registered users and enterprises,
at least a communication device capable of facilitating access to the services of the tag management unit;
at least a smart device application module capable of being installed or embedded with the communication device for facilitating the user to access to the services of the tag management unit;
wherein the tag management unit, the personalized unique location tag, the smart device application module, the communication device, a third-party application module, a web application module are communicably connected with each other through a communication network,
wherein the registered user is connected to the tag management unit through the communication network by using the communication device.

2. The system of claim 1, wherein the tag management module capable of suggesting and assigning available personalized unique location tags to the user depending on user's profile and preferences.

3. The system of claim 1, wherein the suggested or assigned available personalized unique location tag is valid only for a specific period or an unlimited duration.

4. The system of claim 1, wherein the tag management module is capable of storing plurality of physical addresses of the user each with an assigned tag.

5. The system of claim 1, wherein the third party application module is capable of providing a third party access to the tag management unit, wherein the third party includes an individual, a cab driver, a postal delivery person, a courier or shipment delivery person or company, an enterprise or company including an e-commerce company, an administration entity, a public safety agency, a postal service provider, a cab service provider.

6. The system of claim 1, wherein the communication device include a smart phone, a smart watch, a smart device, a smart navigational system, a desktop, a laptop, a PDA, or any other smart communication device capable of communicating over the communication network.

7. The system of claim 1, wherein the personalized unique location tag assigned with a tag value, wherein the tag value includes an alphanumeric string that is uniquely assigned to the user and matched with the corresponding physical location.

8. The system of claim 1, wherein a user specific language is used to generate the personalized unique location tag.

9. A method to generate at least a personalized unique location tag for at least a specific physical location, comprising the steps of:
creating at least a user profile corresponding to the specific physical location and an exact address of the specific physical location by using a smart device application module;
adding a personalized unique location tag to at least the exact address of the specific physical location of the user;
checking validity or acceptance of the personalized unique location tag; and
confirming to the user availability of the personalized unique location tag.

10. The method of claim 9, wherein a method for getting the exact physical location address from the personalized unique location tag of the user for a delivery of at least an item booked online, comprising the steps of:
adding the personalized unique location tag with the online booked item or with an e-commerce company for the delivery of the item at the exact physical location associated with the personalized unique location tag;
requesting the exact physical location of the user from a tag management module by the e-commerce company; and
providing the exact physical location of the user to the e-commerce company.

11. The method of claim 9, wherein shipment systems of different companies, vendors, online web portals integrated with the tag management module to retrieve the exact physical location address of a given personalized unique location tag.

12. The method of claim 9, wherein the exact physical location address includes a building number, street name, zip code, city, and country, or a latitude, longitude geo-point that is selected from a map available in the smart device application module or any other country specific addressing standard.

13. The method of claim 9 further comprising the steps of:
generating the personalized temporary unique location tag by the user for a current location of the user in emergency scenarios;
sharing the generated personalized unique location tag with a plurality of entities including public safety agencies, friends, and relatives; and
retrieving automatically a physical address of the current location of the user,
wherein the generated personalized unique location tag is either chosen by the user or even suggested by the tag management module.

14. The method of claim 9 further comprising steps of assigning the personalized unique location tag to different physical locations during different or non-overlapping time periods.

15. The method of claim 9, wherein the personalized unique location tag is valid for a predefined period of time.

16. The method of claim 9, wherein the user personalized unique location tag is capable of being updated according to change in the physical location or address of the user through a smart device application module.

17. The method of claim 9, wherein distinct personalized unique location tags to be assigned to the same physical locations of different users.

18. The method of claim 9, wherein the personalized unique location tag is capable of being assigned with a new physical address created by the user on-the-fly.

19. A tag management unit for designating at least a physical location of a registered user with at least a personalized unique location tag to easily locate the physical location, comprising:
at least a tag management module capable of verifying and validating personalized unique location tag assignment and updating requests received from the users,
at least a user management module capable of performing user profiling and suggesting at least an appropriate personalized unique location tag to assign for the specific physical location of the user,
at least an enterprise management module capable of allowing enterprises to access services of the tag management unit, wherein the services include personalized unique location tags and their associated physical addresses, user profiles and user information,
at least an usage monitoring and billing module capable of keeping track of number of calls of services provided by the tag management module and making usage of each enterprise in compliance with an enterprise subscription model, wherein the usage monitoring and billing module comprises a billing unit with at least a pre-defined pricing model for generating bills corresponding to uses of the tag management module by the user and securing the payments against the generated bills,
at least a service management module capable of managing services provided by the tag management unit,
at least a database module having at least one of a real time database, a historical database, and an analytics database, wherein the real time database is capable of storing users and enterprises information as well as active tag assignment, wherein the historical database is capable of keeping all historic data in terms of services usage, ended tag assignments, changes of users' profiles, wherein the analytics database includes a data that is used for analytics purpose; and
at least a security and access control module capable of implementing the tag management module, the user management module, the enterprise management module, the usage monitoring and billing module, the service management module, the database module, and intelligence needed to secure the tag management unit and facilitating the access to each service of the tag management unit only to authorized registered users and enterprises.
